(19) United States
(12) Patent Application Publication
(10) Pub. No.: US 2016/0087460 A1
(43) Pub. Date: Mar. 24, 2016

(54) ULTRA-CAPACITOR STRUCTURES WITH MULTIPLE ULTRA-CAPACITOR CELLS AND METHODS THEREOF

(71) Applicant: THE PAPER BATTERY COMPANY, INC., Troy, NY (US)

(72) Inventors: Dave RICH, East Greenbush, NY (US); Anthony SUDANO, Laval (CA); Sudhir Rajaram KULKARNI, Albany, NY (US); Staci TRIFILO, Scotia, NY (US)

(73) Assignee: THE PAPER BATTERY COMPANY, INC., Troy, NY (US)

(21) Appl. No.: 14/576,316

(22) Filed: Dec. 19, 2014

Related U.S. Application Data
(60) Provisional application No. 62/054,148, filed on Sep. 23, 2014.

(51) Int. Cl. H02J 7/00

(52) U.S. Cl. CPC H02J 7/007

(57) ABSTRACT

Ultra-capacitor structures and methods thereof are presented. In one aspect, a structure includes: an ultra-capacitor structure having multiple ultra-capacitor cells; and a switching mechanism, the switching mechanism being operable to selectively connect different electrical interconnect configurations of the multiple ultra-capacitor cells of the ultra-capacitor structure to provide any one of a plurality of different voltages or currents to at least one electrical load, and to selectively control charging of the multiple ultra-capacitor cells using energy from at least one battery. In another aspect, a method includes: obtaining an ultra-capacitor structure having multiple ultra-capacitor cells; connecting different electrical interconnect configurations of the multiple ultra-capacitor cells of the ultra-capacitor structure to provide any one of a plurality of different voltages or currents to at least one electrical load; and charging the ultra-capacitor structure using energy from at least one battery.

### CROSS-REFERENCE TO RELATED APPLICATIONS

This application claims the benefit of U.S. Provisional Patent Application No. 62/054,148, filed Sep. 23, 2014, which is hereby incorporated herein by reference in its entirety.

### FIELD OF THE INVENTION

The present invention relates to ultra-capacitor structures and more particularly to ultra-capacitor structures with multiple ultra-capacitor cells, and methods thereof.

### BACKGROUND OF THE INVENTION

Modern electronic devices make use of numerous electronic components requiring different voltages or currents for operation. For instance, memory components, central processing units, and radio transceivers may all operate at different nominal voltages or currents. In addition, modern electronic devices and components thereof can require different voltages or currents for different periods of time. In one example, a mobile electronic device can have a radio transceiver requiring different voltages or currents during radio reception, radio standby, or radio transmission. In another example, the mobile electronic device can have a camera component requiring different voltages or currents during camera flash or camera focusing.

Typically, electronic devices, such as mobile electronic devices, have a battery with a single nominal voltage, and multiple different voltages or currents are achieved through the use of direct current to direct current (DC-DC) conversion circuits. However, DC-DC conversion circuits are inefficient, dissipating energy to the surrounding environment in the form of heat or radiation. The dissipated energy can adversely impact performance of the electronic device, for example, due to increased temperature from thermal dissipation, and decreased energy capacity for powering the electronic devices.

### BRIEF SUMMARY

The shortcomings of the prior art are overcome, and additional advantages are provided, through the provision, in one aspect, of a structure. The structure includes: an ultra-capacitor structure having multiple ultra-capacitor cells; and a switching mechanism, the switching mechanism being operable to selectively connect different electrical interconnect configurations of the multiple ultra-capacitor cells of the ultra-capacitor structure to provide any one of a plurality of different voltages or currents to at least one electrical load, and to selectively control charging of the multiple ultra-capacitor cells using energy from at least one battery.

In another aspect, an electronic system is presented. The electronic system includes: an ultra-capacitor structure having multiple ultra-capacitor cells; at least one battery; and a switching mechanism, the switching mechanism being operable to selectively connect different electrical interconnect configurations of the multiple ultra-capacitor cells of the ultra-capacitor structure to provide any one of a plurality of different voltages or currents to at least one electrical load, and to selectively control charging of the multiple ultra-capacitor cells using energy from the at least one battery.

In a further aspect, a method is presented. The method includes: obtaining an ultra-capacitor structure having multiple ultra-capacitor cells; connecting different electrical interconnect configurations of the multiple ultra-capacitor cells of the ultra-capacitor structure to provide any one of a plurality of different voltages or currents to at least one electrical load; and charging the ultra-capacitor structure using energy from at least one battery.

Additional features and advantages are realized through the techniques of the present invention. Other embodiments and aspects of the invention are described in detail herein and are considered a part of the claimed invention.

### BRIEF DESCRIPTION OF THE SEVERAL VIEWS OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIGS. 1A-1C depict embodiments of methods using an ultra-capacitor structure having multiple ultra-capacitor cells, in accordance with one or more aspects of the present invention;

FIG. 2A depicts a structure having an ultra-capacitor structure and a switching mechanism, in accordance with one or more aspects of the present invention;

FIG. 2B depicts an electrical interconnect configuration of multiple ultra-capacitor cells of the ultra-capacitor structure of FIG. 2A, in accordance with one or more aspects of the present invention;

FIG. 2C depicts another electrical interconnect configuration of the multiple ultra-capacitor cells of the ultra-capacitor structure of FIG. 2A, in accordance with one or more aspects of the present invention;

FIG. 3A depicts a parallel electrical interconnect configuration of at least two ultra-capacitor cells of an ultra-capacitor structure, in accordance with one or more aspects of the present invention;

FIG. 3B depicts a series electrical interconnect configuration of the at least two ultra-capacitor cells of the ultra-capacitor structure of FIG. 3A, in accordance with one or more aspects of the present invention; and

FIGS. 4A-4D depict an ultra-capacitor structure having multiple ultra-capacitor cells, in accordance with one or more aspects of the present invention.

### DETAILED DESCRIPTION

Aspects of the present invention and certain features, advantages, and details thereof, are explained more fully below with reference to the non-limiting examples illustrated in the accompanying drawings. Descriptions of well-known materials, fabrication tools, processing techniques, etc., are omitted so as not to unnecessarily obscure the invention in detail. It should be understood, however, that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure.

The present disclosure provides, in part, ultra-capacitor structures with multiple ultra-capacitor cells and methods thereof, which can be used in conjunction with electronic devices. By way of explanation, an electronic device can have numerous electronic components requiring different voltages or currents for operation. In addition, the different voltages or currents may be required for different periods of time. The ultra-capacitor structures described herein can provide multiple different voltages or currents, for different periods of times, to the electronic components. For example, different voltages or currents can be provided by different electrical interconnect configurations of the multiple ultra-capacitor cells of the ultra-capacitor structure.

As used herein, an ultra-capacitor is, for instance, an electrochemical capacitor that includes an electrolyte disposed between electrodes. An electrolyte is a substance through which electricity may pass, and may be, for example, a fluid, solid, semisolid, or flowable material. One example of an ultra-capacitor is an electrochemical double layer capacitor (EDLC), which may store electrical energy by the separation of charge, for instance, in a double layer of ions, at the interface between the surface of a conductive electrode and an electrolyte. Another term for an ultra-capacitor is a supercapacitor. An ultra-capacitor structure may include one or more ultra-capacitor cells.

Energy storage devices, including ultra-capacitor structures and batteries, may be characterized by an energy density and a power density. The energy density (also known as the specific energy) of an energy storage device is defined as the amount of energy stored per unit mass of the device, and the power density is defined as the rate per unit mass at which energy may be transferred to or from the device. Different types of energy storage devices may be compared by comparing their respective energy densities and power densities. As one example, an activated carbon ultra-capacitor may have, for example one-tenth of the energy density of a conventional lithium-ion rechargeable battery, but have, for example, 10 to 100 times the power density of the conventional lithium-ion rechargeable battery. Therefore, an ultra-capacitor may deliver a relatively large amount of energy to an electrical load over a relatively short time, as compared to a battery that may deliver a relatively small amount of energy to an electrical load over a relatively long time.

In operation, an electronic device, such as a mobile electronic device, can have multiple different operating requirements for voltage, current, power, energy, and/or RC (resistance times capacitance) time constants. For instance, certain components of the electronic device, such as a central processing unit, a memory storage device, or a display screen may steadily consume power. In addition, other components of the electronic device, such as radio transceiver, a camera flash, or a pump portion of a medical device, such as an insulin pump, may intermittently consume high power for short durations. In such a case, a battery may be used for long term storage of energy, and may be used to charge ultra-capacitor cells of an ultra-capacitor structure, which may then deliver bursts of higher levels of energy at appropriate voltage, current, power, and/or RC time constant, as needed by various electronic components.

Advantageously, the ultra-capacitor structures described herein allow, for example, a single battery at a specific nominal voltage to be used to power an electronic device, with the ultra-capacitor structures converting the power therefrom into appropriate voltages or currents as needed. This enables the elimination of inefficient and/or space consuming components, such as numerous capacitors or DC-DC converters, allowing for maximum power efficiency in a minimal footprint electronic device. For example, the ultra-capacitor structures described herein can provide several different voltages or currents to several different electrical loads, such as electronic components, either at the same time, or sequentially. Concurrently with providing several different voltages or currents to electronic components, the ultra-capacitor structures described herein can be charged using energy from at least one battery.

Generally stated, provided herein, in one aspect, is a structure. The structure includes: an ultra-capacitor structure having multiple ultra-capacitor cells; and a switching mechanism, the switching mechanism being operable to selectively connect different electrical interconnect configurations of the multiple ultra-capacitor cells of the ultra-capacitor structure to provide any one of a plurality of different voltages or currents to at least one electrical load, and to selectively control charging of the multiple ultra-capacitor cells using energy from at least one battery.

In one embodiment, the switching mechanism is operable to selectively connect an electrical interconnect configuration of first ultra-capacitor cells of the ultra-capacitor structure to provide a voltage or current to the at least one electrical load, and concurrently therewith to selectively control charging of second ultra-capacitor cells of the ultra-capacitor structure using energy from the at least one battery.

In another embodiment, the switching mechanism is operable to selectively connect a first electrical interconnect configuration of first ultra-capacitor cells of the ultra-capacitor structure to provide a first voltage or current to a first electrical load of the at least one electrical load, and concurrently therewith selectively connect a second electrical interconnect configuration of second ultra-capacitor cells of the ultra-capacitor structure to provide a second voltage or current to a second electrical load of the at least one electrical load, wherein the first voltage or current and the second voltage or current are different voltages or currents.

In a further embodiment, the switching mechanism is operable to selectively connect a first electrical interconnect configuration of first ultra-capacitor cells of the ultra-capacitor structure to provide a first voltage or current to the at least one electrical load during a first period of time, and selectively connect a second electrical interconnect configuration of second ultra-capacitor cells of the ultra-capacitor structure to provide a second voltage or current to the at least one electrical load during a second period of time, wherein the first period of time and the second period of time are sequential periods of time. In such a case, the switching mechanism is operable to selectively control charging of the second ultra-capacitor cells of the ultra-capacitor structure using energy from the at least one battery during the first period of time, and selectively control charging of the first ultra-capacitor cells of the ultra-capacitor structure using energy from the at least one battery during the second period of time.

In one implementation, a configuration of the different electrical interconnect configurations of the multiple ultra-capacitor cells of the ultra-capacitor structure comprises at least two of the multiple ultra-capacitor cells electrically connected in series configuration to the at least one electrical load. In another implementation, a configuration of the different electrical interconnect configurations of the multiple ultra-capacitor cells of the ultra-capacitor structure comprises at least two of the multiple ultra-capacitor cells electrically connected in parallel configuration to the at least one electrical load.

In a further implementation, the structure further comprises a controller, the controller being coupled to the switching mechanism and operable to control the switching mechanism to selectively electrically connect any one of the different electrical interconnect configurations of the multiple ultra-capacitor cells of the ultra-capacitor structure to the at least one electrical load, responsive in part to energy levels of the multiple ultra-capacitor cells.

In another aspect, an electronic system is presented. The electronic system includes: an ultra-capacitor structure having multiple ultra-capacitor cells; at least one battery; and a switching mechanism, the switching mechanism being operable to selectively connect different electrical interconnect configurations of the multiple ultra-capacitor cells of the ultra-capacitor structure to provide any one of a plurality of different voltages or currents to at least one electrical load, and to selectively control charging of the multiple ultra-capacitor cells using energy from the at least one battery.

Reference is made below to the drawings, which are not drawn to scale for ease of understanding, wherein the same reference numbers used throughout different figures designate the same or similar components.

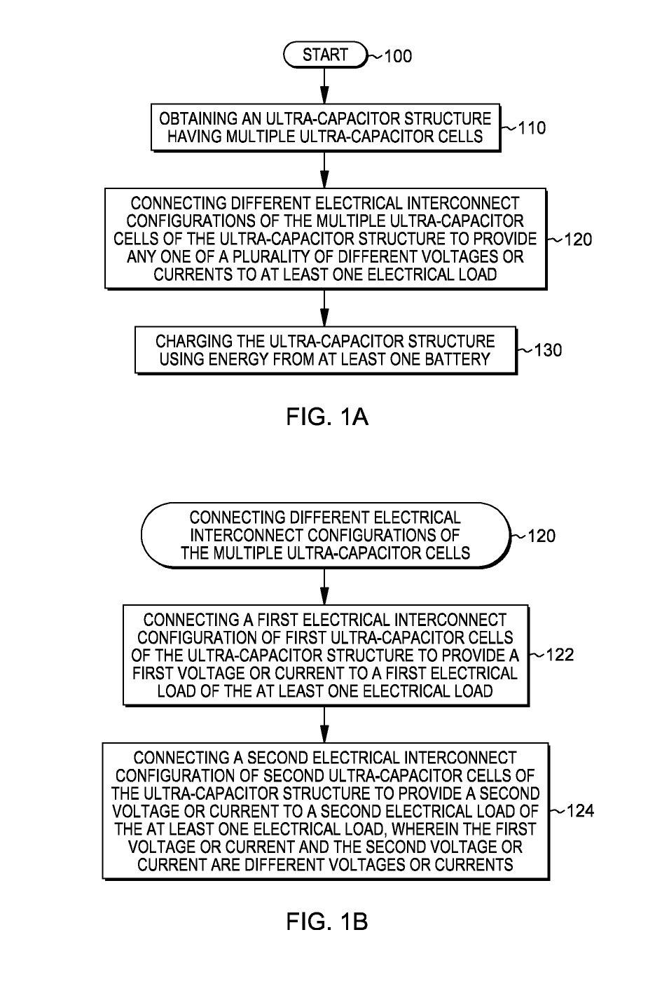

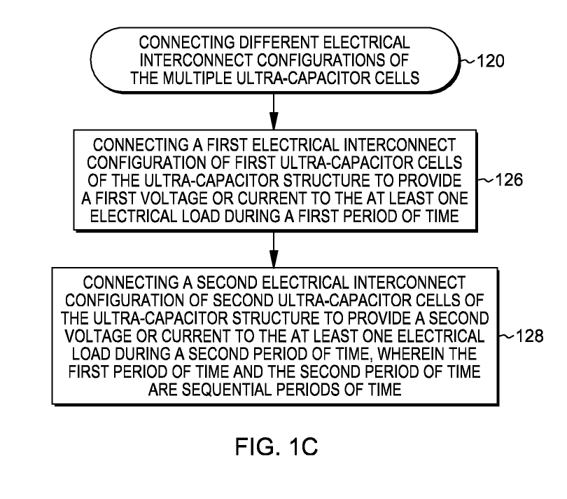

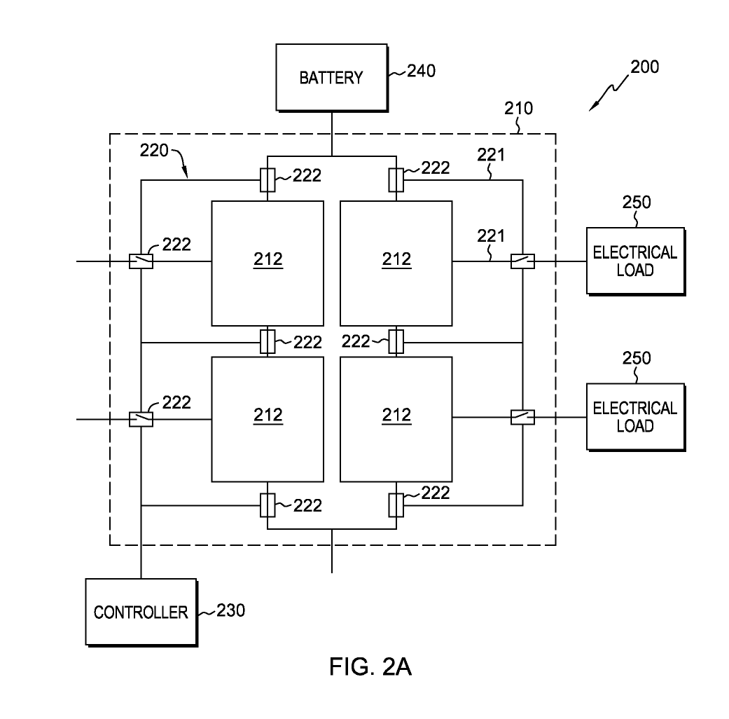

FIGS. 1A-1C depict embodiments of methods using an ultra-capacitor structure having multiple ultra-capacitor cells, in accordance with one or more aspects of the present invention. In one embodiment, the method includes: obtaining an ultra-capacitor structure having multiple ultra-capacitor cells 110; connecting different electrical interconnect configurations of the multiple ultra-capacitor cells of the ultra-capacitor structure to provide any one of a plurality of different voltages or currents to at least one electrical load 120; and charging the ultra-capacitor structure using energy from at least one battery 130.

In another embodiment, the connecting 120 includes: connecting a first electrical interconnect configuration of first ultra-capacitor cells of the ultra-capacitor structure to provide a first voltage or current to a first electrical load of the at least one electrical load 122; and connecting a second electrical interconnect configuration of second ultra-capacitor cells of the ultra-capacitor structure to provide a second voltage or current to a second electrical load of the at least one electrical load, wherein the first voltage or current and the second voltage or current are different voltages or currents 124.

In a further embodiment, the connecting 120 includes: connecting a first electrical interconnect configuration of first ultra-capacitor cells of the ultra-capacitor structure to provide a first voltage or current to the at least one electrical load during a first period of time 126; and connecting a second electrical interconnect configuration of second ultra-capacitor cells of the ultra-capacitor structure to provide a second voltage or current to the at least one electrical load during a second period of time, wherein the first period of time and the second period of time are sequential periods of time 128.

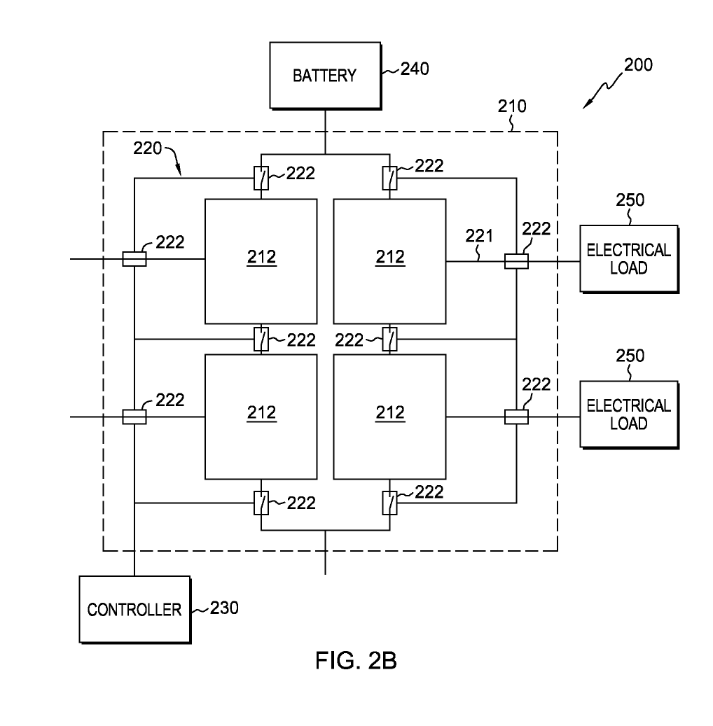

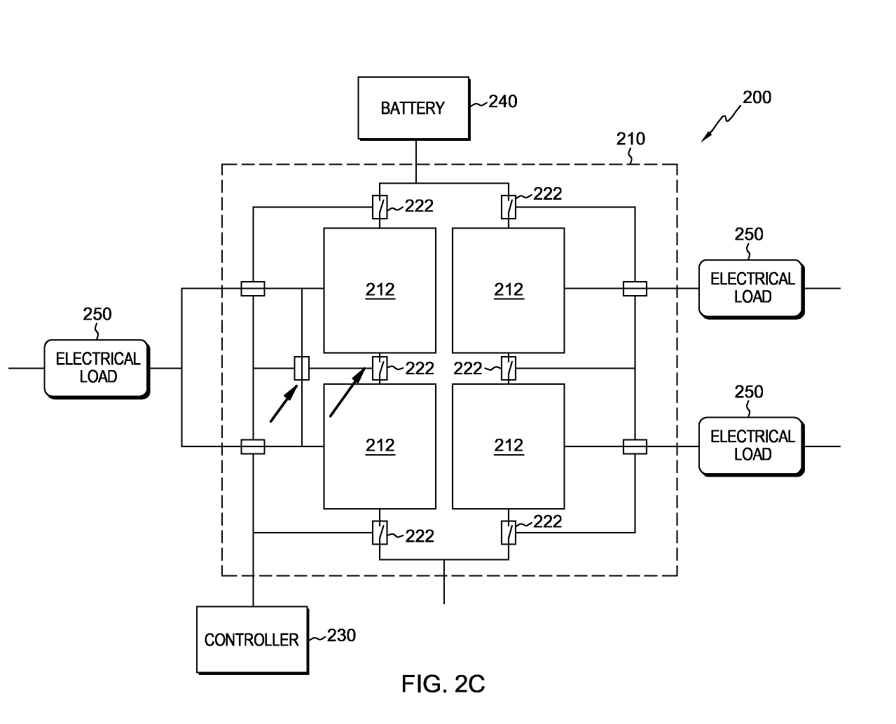

FIG. 2A depicts a structure 200 having an ultra-capacitor structure 210 and a switching mechanism 220, in accordance with one or more aspects of the present invention. In one embodiment, switching mechanism 220 is operable to selectively connect different electrical interconnect configurations of multiple ultra-capacitor cells 212 of ultra-capacitor structure 210.

In particular, FIG. 2A depicts an electrical interconnect configuration of multiple ultra-capacitor cells 212 of ultra-capacitor structure 210. For example, the electrical interconnect configuration can be implemented by switching mechanism 220 including switches 222. In various embodiments, switches 222 can be or include transistors or electromechanical relays, and when closed allow the flow of current. The symbolic schematic representation used for the switches shows either a connected line, indicating a closed state (allowing the flow of current) or disconnected lines, indicating an open state (not allowing the flow of current).

In the illustrated embodiment, switches 222 are interspersed, or co-located, with ultra-capacitor cells 212. In another embodiment, the switching mechanism can be implemented in one or more centralized integrated circuits, such as, for example, an application specific integrated circuit (ASIC) or a controller, such as an embedded micro-controller. In such a case, separate or combined control lines and power lines can be provided to interconnect the multiple ultra-capacitor cells of the ultra-capacitor structure to the switching mechanism. For instance, connections 221 can include both control lines and power lines. As one specific example, the controller can be an MSP430 Micro-controller available from Texas Instruments, Inc., of Dallas, Tex.

By way of example, in the embodiment of FIG. 2A, some of switches 222 are open and others of switches 222 are closed, so that at least one battery 240 is connected to ultra-capacitor structure 210 which has an electrical interconnect configuration with two parallel groups of two series ultra-capacitor cells 212. In such a case, switching mechanism 220 selectively controls charging of ultra-capacitor cells 212 using energy from at least one battery 240. As depicted, some of switches 222 that are located between electrical loads 250 and ultra-capacitor structure 220 are open during charging of ultra-capacitor structure 210, so that current will not flow to electrical loads 250.

In a further embodiment, structure 200 includes a controller 230 coupled to switching mechanism 220. In such a case, controller 230 can be operable to control switching mechanism 220 to selectively electrically connect any one of the different electrical interconnect configurations of multiple ultra-capacitor cells 212. By way of example, controller 230 can selectively electrically connect ultra-capacitor cells 212 responsive in part to energy levels of ultra-capacitor cells 212. For instance, controller 230 can determine that one group of ultra-capacitor cells 212 is nearly depleted, and selectively control charging of that group of ultra-capacitor cells 212 using energy from at least one battery 240.

In one example, each ultra-capacitor cell includes electrodes separated by a separator and electrically connected by ions of an electrolyte located between the electrodes. For instance, the electrodes may be fabricated of a porous or spongy material, which may have a large specific surface area. Examples of electrode materials include as activated carbon, amorphous carbon, carbon aerogel, graphene, or carbon nanotubes.

In another example, electrode materials can have a specific surface area of 500-1000 square meters per gram, due to micro-porosity. In addition, the electrolyte may include a solvent with dissolved chemicals, such as potassium hydroxide (KOH). Further, the electrodes can be connected to one or more current collectors, which may include a conductive material, such as a metal, for instance, aluminum or copper. In another example, the electrode material, such as graphite, may be painted onto the current collectors. In such a case, the current collectors can act as terminals, such as positively charged anodes or negatively charged cathodes of the ultra-capacitor cells. Various materials may be used in the formation of an ultra-capacitor structure. For example, polymers, such as polyethylene terephthalate (PET), may be used to provide electrical insulation or to contain electrolytes, and adhesives may be used to bond layers together.

FIG. 2B depicts another electrical interconnect configuration of multiple ultra-capacitor cells 212 of ultra-capacitor structure 210 of FIG. 2A, in accordance with one or more aspects of the present invention. As illustrated, switching mechanism 220, including switches 222, selectively connects an electrical interconnect configuration of multiple ultra-capacitor cells 212 of ultra-capacitor structure 210 to provide voltages or currents to at least one electrical load 250.

In the embodiment of FIG. 2B, switches 222 between ultra-capacitor structure 210 and at least one battery 240 are open, preventing voltages or currents from flowing between at least one battery 240 and ultra-capacitor structure 210, and switches 222 between ultra-capacitor structure 210 and electrical loads 250 are closed, allowing voltages or currents to flow between ultra-capacitor structure 210 and electrical loads 250.

In one embodiment, selectively connecting can include providing any one of a plurality of different voltages or currents to at least one electrical load 250. In another embodiment, different numbers of ultra-capacitor cells can be selectively connected to the different electrical loads to provide different voltages or currents. For instance, an ultra-capacitor structure may include numerous ultra-capacitor cells, each having a voltage capacity of 2 volts (V). In such a case, switching mechanism 220 can selectively connect 3 ultra-capacitor cells in series to provide 6 V to an electrical load, or 4 ultra-capacitor cells in series to provide 8 V to an electrical load, and so forth.

In the embodiment of FIG. 2B, some of switches 222 between ultra-capacitor structure 210 and battery 240 are open, thereby disconnecting the battery from the ultra-capacitor structure. In such a case, ultra-capacitor structure 210 can be used to selectively power at least one electrical load 250, which may be a component of an electronic device.

FIG. 2C depicts the switching mechanism of FIG. 2A selectively connecting another electrical interconnect configuration of multiple ultra-capacitor cells 212 of ultra-capacitor structure 210 to provide another voltage or current, in accordance with one or more aspects of the present invention. In the embodiment of FIG. 2C, two ultra-capacitor cells 212 (shown on the left side of FIG. 2C) are connected in parallel with one electrical load 250, and two ultra-capacitor cells 212 (shown on the right side of FIG. 2C) are connected to two electrical loads 250. Such a configuration allows, for example, three different electrical loads to be provided with three different voltages or currents.

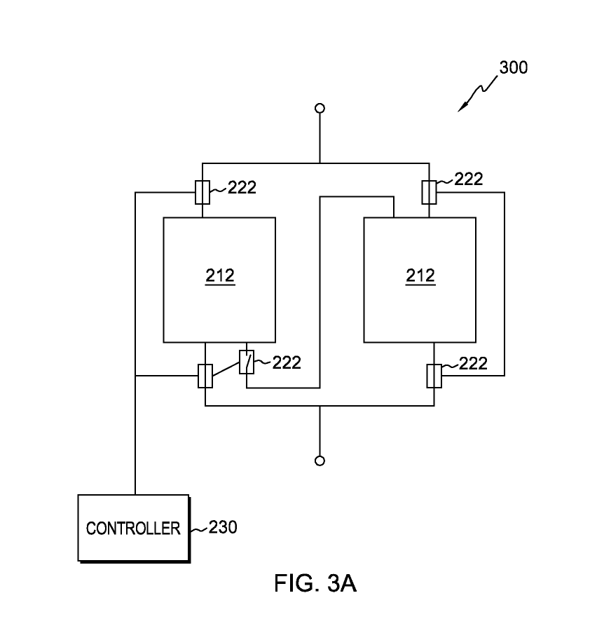

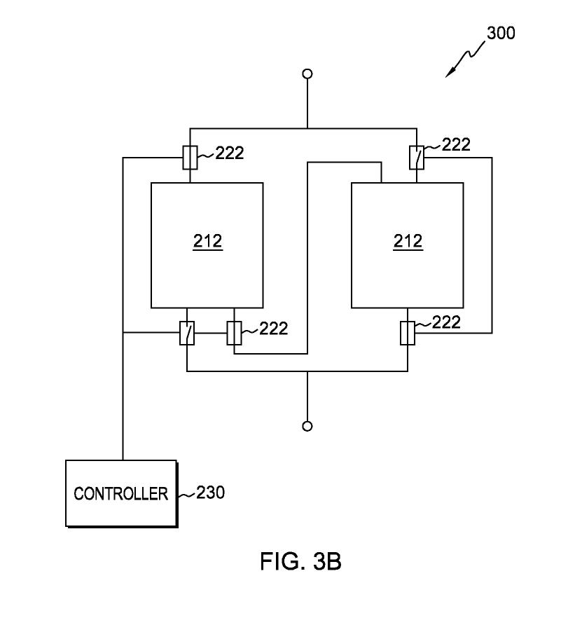

FIGS. 3A-3B depict a parallel (FIG. 3A) and serial (FIG. 3B) electrical interconnect configuration of at least two ultra-capacitor cells 212 of an ultra-capacitor structure, in accordance with one or more aspects of the present invention. In the illustrated embodiment, two ultra-capacitor cells 212 can be alternately connected in either a parallel electrical interconnect configuration or a series electrical interconnect configuration by use of a switching mechanism including switches 212. In another embodiment, numerous ultra-capacitor cells may be connected in a similar manner to allow for interchangeable series and parallel configurations.

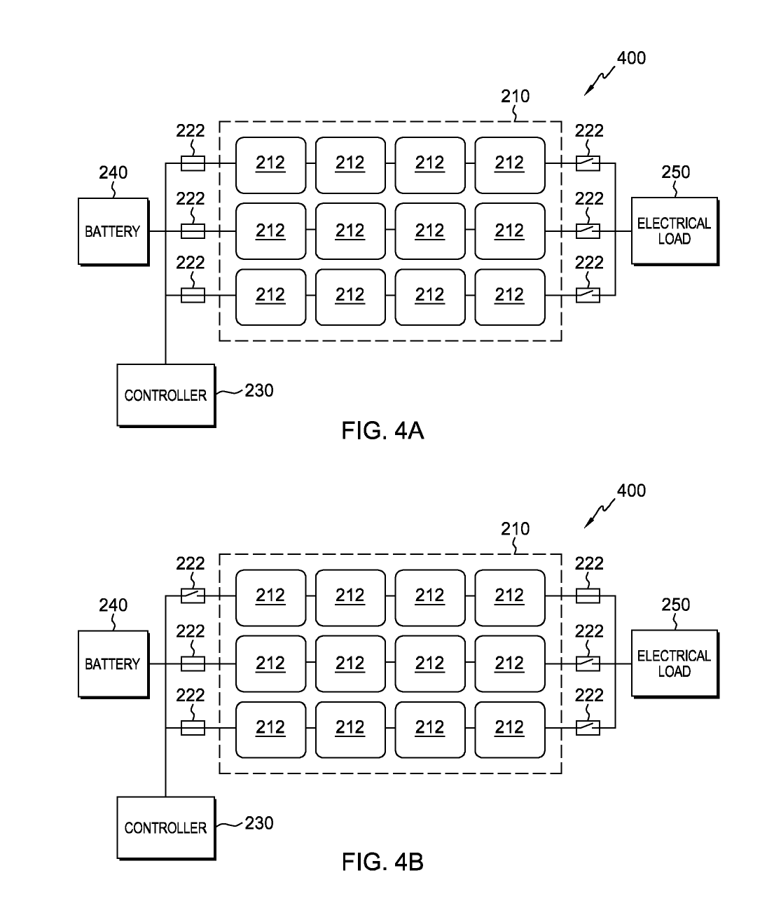

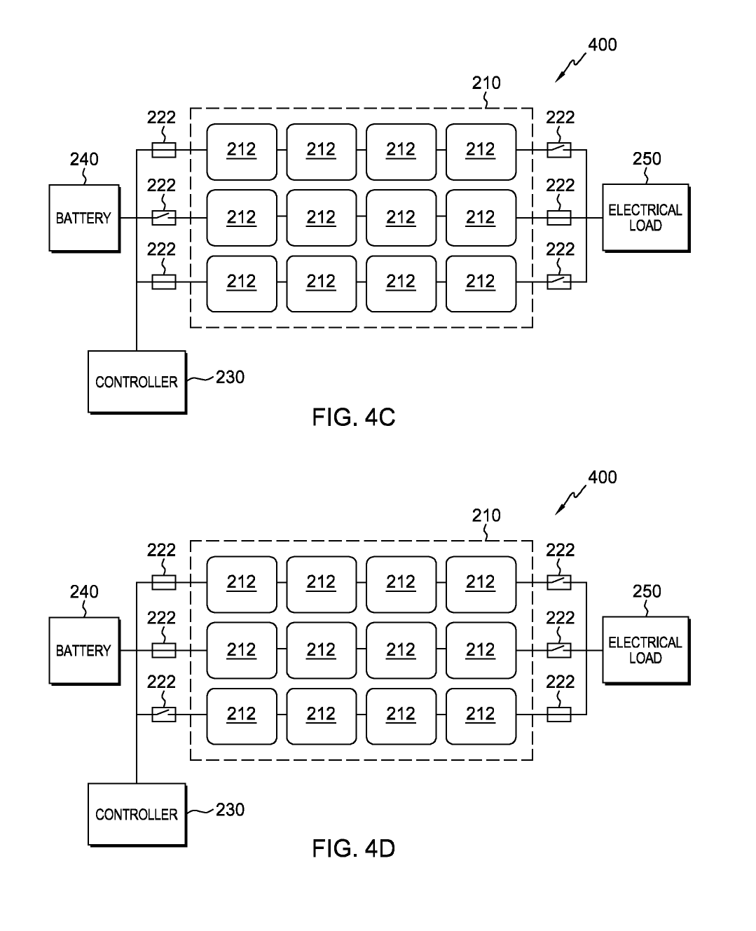

FIGS. 4A-4D depict a structure 400 having an ultra-capacitor structure 410 and a switching mechanism, in accordance with one or more aspects of the present invention. As illustrated, ultra-capacitor structure 410 includes twelve ultra-capacitor cells 212, with a top, middle, and bottom row each having four ultra-capacitor cells 212 connected in series.

By way of explanation, the techniques described herein allow for dynamic, on-the-fly configurations of ultra-capacitor cells 212 to achieve a variety of different design goals. For instance, numerous ultra-capacitor cells may be connected so that a continuous stream of energy can be delivered from a first subset of ultra-capacitor cells, and concurrently therewith, a second subset of ultra-capacitor cells can simultaneously be charged from the battery. In such an example, after the first subset of ultra-capacitor cells has been depleted, the second subset can be seamlessly switched on the fly to deliver a stream of energy, and the first subset can be charged from the battery.

In one embodiment, continuous power delivery to an electrical load can include using a smoothing circuit to deliver a constant voltage to the electrical load. For example, after the first subset of ultra-capacitor cells has been depleted, the second subset can be switched to deliver power to the electrical load before switching the first subset to be charged from the battery. In such configuration (make-before-break configuration), both the first and second subsets can be connected to the electrical load through a smoothing circuit, to ensure that a constant voltage is delivered to the electrical load. In one specific example, both subsets can be connected to the electrical load for an overlap of 0.1-10 milliseconds. In other cases, where an electronic component does not require precise input voltages, a smoothing circuit may not be used.

In another embodiment, a subset of ultra-capacitor cells can be ready to deliver an energy pulse for a short duration when needed, for example, to power the flash of a camera. In a further embodiment, a first subset of ultra-capacitor cells can be connected to an electrical load for a particular time period, and as the energy of the first subset is depleted, a second subset can be connected to the electrical load, so that a voltage delivered to the electrical load remains within a pre-determined range.

Turning to the embodiment of FIG. 4A, the switching mechanism, which includes switches 222, selectively controls charging of all twelve ultra-capacitor cells 212 of ultra-capacitor structure 410 using energy from at least one battery 240. In such a case, selectively controlling charging is achieved by closing three switches 222 on the left hand side of structure 400 (for example, switches 222 between ultra-capacitor structure 410 and battery 240) and opening three switches 222 on the right hand side of structure (for example, switches 222 between ultra-capacitor structure 410 and electrical load 250). In one example, structure 400 operates as described in FIG. 4A during a first time period.

In the embodiment of FIG. 4B, the switching mechanism selectively connects (for example, by opening some switches 222 and closing other switches 222) an electrical interconnect configuration of the top row of four ultra-capacitor cells 212 to provide a voltage or current to at least one electrical load 250. In one specific example, if each ultra-capacitor cell 212 has a voltage of 2.4 V, such a series electrical interconnect configuration of four cells provides 9.6 V to electrical load 250. Continuing with the embodiment of FIG. 4A, concurrently with the top row of ultra-capacitor cells 212 providing a voltage or current to electrical load 250, the switching mechanism selectively controls charging of the other eight ultra-capacitor cells 212 (e.g., the middle and bottom rows) of ultra-capacitor structure 410 using energy from at least one battery 240. In one example, structure 400 operates as described in FIG. 4B during a second time period. In such a case, during the second time period, controller 230 can sense energy levels of the ultra-capacitor cells 410 which are providing a voltage or current to electrical load 250, and as the energy from those cells are dissipated, controller 230 can control switches 222 as illustrated in FIG. 4C.

In the embodiment of FIG. 4C, the switching mechanism selectively connects an electrical interconnect configuration of the middle row of four ultra-capacitor cells 212 to provide a voltage or current to at least one electrical load 250. Continuing with the embodiment of FIG. 4C, concurrently with the middle row of ultra-capacitor cells 212 providing a voltage or current to electrical load 250, the switching mechanism selectively controls charging of the other eight ultra-capacitor cells 212 (e.g., the top and bottom rows) of ultra-capacitor structure 410 using energy from at least one battery 240. In one example, structure 400 operates as described in FIG. 4B during a third time period. In such a case, during the third time period, controller 230 can sense energy levels of the ultra-capacitor cells 410 which are providing a voltage or current to electrical load 250, and as the energy from those cells are dissipated, controller 230 can control switches 222 as illustrated in FIG. 4D.

In the embodiment of FIG. 4D, the switching mechanism selectively connects an electrical interconnect configuration of the bottom row of four ultra-capacitor cells 212 to provide a voltage or current to at least one electrical load 250. Continuing with the embodiment of FIG. 4D, concurrently with the bottom row of ultra-capacitor cells 212 providing a voltage or current to electrical load 250, the switching mechanism selectively controls charging of the other eight ultra-capacitor cells 212 (e.g., the top and middle rows) of ultra-capacitor structure 410 using energy from at least one battery 240.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. A structure comprising:
an ultra-capacitor structure having multiple ultra-capacitor cells; and
a switching mechanism, the switching mechanism being operable to selectively connect different electrical interconnect configurations of the multiple ultra-capacitor cells of the ultra-capacitor structure to provide any one of a plurality of different voltages or currents to at least one electrical load, and to selectively control charging of the multiple ultra-capacitor cells using energy from at least one battery.

2. The structure of claim 1, wherein the switching mechanism is operable to selectively connect an electrical interconnect configuration of first ultra-capacitor cells of the ultra-capacitor structure to provide a voltage or current to the at least one electrical load, and concurrently therewith to selectively control charging of second ultra-capacitor cells of the ultra-capacitor structure using energy from the at least one battery.

3. The structure of claim 1, wherein the switching mechanism is operable to selectively connect a first electrical interconnect configuration of first ultra-capacitor cells of the ultra-capacitor structure to provide a first voltage or current to a first electrical load of the at least one electrical load, and concurrently therewith selectively connect a second electrical interconnect configuration of second ultra-capacitor cells of the ultra-capacitor structure to provide a second voltage or current to a second electrical load of the at least one electrical load, wherein the first voltage or current and the second voltage or current are different voltages or currents.

4. The structure of claim 3, wherein the first electrical interconnect configuration of the multiple ultra-capacitor cells of the ultra-capacitor structure comprises at least two of the first ultra-capacitor cells electrically connected in series configuration to the first electrical load.

5. The structure of claim 3, wherein the second electrical interconnect configuration of the multiple ultra-capacitor cells of the ultra-capacitor structure comprises at least two of the second ultra-capacitor cells electrically connected in parallel configuration to the second electrical load.

6. The structure of claim 1, wherein the switching mechanism is operable to selectively connect a first electrical interconnect configuration of first ultra-capacitor cells of the ultra-capacitor structure to provide a first voltage or current to the at least one electrical load during a first period of time, and selectively connect a second electrical interconnect configuration of second ultra-capacitor cells of the ultra-capacitor structure to provide a second voltage or current to the at least one electrical load during a second period of time, wherein the first period of time and the second period of time are sequential periods of time.

7. The structure of claim 6, wherein the switching mechanism is operable to selectively control charging of the second ultra-capacitor cells of the ultra-capacitor structure using energy from the at least one battery during the first period of time, and selectively control charging of the first ultra-capacitor cells of the ultra-capacitor structure using energy from the at least one battery during the second period of time.

8. The structure of claim 1, wherein a configuration of the different electrical interconnect configurations of the multiple ultra-capacitor cells of the ultra-capacitor structure comprises at least two of the multiple ultra-capacitor cells electrically connected in series configuration to the at least one electrical load.

9. The structure of claim 1, wherein a configuration of the different electrical interconnect configurations of the multiple ultra-capacitor cells of the ultra-capacitor structure comprises at least two of the multiple ultra-capacitor cells electrically connected in parallel configuration to the at least one electrical load.

10. The structure of claim 1, further comprising a controller, the controller being coupled to the switching mechanism and operable to control the switching mechanism to selectively electrically connect any one of the different electrical interconnect configurations of the multiple ultra-capacitor cells of the ultra-capacitor structure to the at least one electrical load, responsive in part to energy levels of the multiple ultra-capacitor cells.

11. The structure of claim 10, wherein the controller is operable to control the switching mechanism to selectively connect an electrical interconnect configuration of first ultra-capacitor cells of the ultra-capacitor structure to provide a voltage or current to the at least one electrical load, and concurrently therewith selectively control charging of second ultra-capacitor cells of the ultra-capacitor structure using energy from the at least one battery.

12. The structure of claim 10, wherein the controller is operable to control the switching mechanism to selectively connect a first electrical interconnect configuration of first ultra-capacitor cells of the ultra-capacitor structure to provide a first voltage or current to a first electrical load of the at least one electrical load, and concurrently therewith selectively connect a second electrical interconnect configuration of second ultra-capacitor cells of the ultra-capacitor structure to provide a second voltage or current to a second electrical load of the at least one electrical load, wherein the first voltage or current and the second voltage or current are different voltages or currents.

13. The structure of claim 10, wherein the controller is operable to control the switching mechanism to selectively connect a first electrical interconnect configuration of first ultra-capacitor cells of the ultra-capacitor structure to provide a first voltage or current to the at least one electrical load during a first period of time, and selectively connect a second electrical interconnect configuration of second ultra-capacitor cells of the ultra-capacitor structure to provide a second voltage or current to the at least one electrical load during a second period of time, wherein the first period of time and the second period of time are sequential periods of time.

14. An electronic system comprising:
an ultra-capacitor structure having multiple ultra-capacitor cells;
at least one battery; and
a switching mechanism, the switching mechanism being operable to selectively connect different electrical interconnect configurations of the multiple ultra-capacitor cells of the ultra-capacitor structure to provide any one of a plurality of different voltages or currents to at least one electrical load, and to selectively control charging of the multiple ultra-capacitor cells using energy from the at least one battery.

15. The electronic system of claim 14, wherein the switching mechanism is operable to selectively connect an electrical interconnect configuration of first ultra-capacitor cells of the ultra-capacitor structure to provide a voltage or current to the at least one electrical load, and concurrently therewith to selectively control charging of second ultra-capacitor cells of the ultra-capacitor structure using energy from the at least one battery.

16. The electronic system of claim 14, wherein the switching mechanism is operable to selectively connect a first electrical interconnect configuration of first ultra-capacitor cells of the ultra-capacitor structure to provide a first voltage or current to a first electrical load of the at least one electrical load, and concurrently therewith selectively connect a second electrical interconnect configuration of second ultra-capacitor cells of the ultra-capacitor structure to provide a second voltage or current to a second electrical load of the at least one electrical load, wherein the first voltage or current and the second voltage or current are different voltages or currents.

17. The electronic system of claim 14, wherein the switching mechanism is operable to selectively connect a first electrical interconnect configuration of first ultra-capacitor cells of the ultra-capacitor structure to provide a first voltage or current to the at least one electrical load during a first period of time, and selectively connect a second electrical interconnect configuration of second ultra-capacitor cells of the ultra-capacitor structure to provide a second voltage or current to the at least one electrical load during a second period of time, wherein the first period of time and the second period of time are sequential periods of time.

18. A method comprising:
obtaining an ultra-capacitor structure having multiple ultra-capacitor cells;
connecting different electrical interconnect configurations of the multiple ultra-capacitor cells of the ultra-capacitor structure to provide any one of a plurality of different voltages or currents to at least one electrical load; and
charging the ultra-capacitor structure using energy from at least one battery.

19. The method of claim 18, wherein the connecting comprises:
connecting a first electrical interconnect configuration of first ultra-capacitor cells of the ultra-capacitor structure to provide a first voltage or current to a first electrical load of the at least one electrical load; and
connecting a second electrical interconnect configuration of second ultra-capacitor cells of the ultra-capacitor structure to provide a second voltage or current to a second electrical load of the at least one electrical load, wherein the first voltage or current and the second voltage or current are different voltages or currents.

20. The method of claim 18, wherein the connecting comprises:
connecting a first electrical interconnect configuration of first ultra-capacitor cells of the ultra-capacitor structure to provide a first voltage or current to the at least one electrical load during a first period of time; and
connecting a second electrical interconnect configuration of second ultra-capacitor cells of the ultra-capacitor structure to provide a second voltage or current to the at least one electrical load during a second period of time, wherein the first period of time and the second period of time are sequential periods of time.
